(19) United States
(12) Patent Application Publication
(10) Pub. No.: US 2011/0174296 A1
(43) Pub. Date: Jul. 21, 2011

(54) SOLAR-THERMAL ENERGY STORAGE SYSTEM AND METHODS OF MAKING AND USING SAME

(75) Inventor: Alexander I. Kalina, Hillsborough, CA (US)

(73) Assignee: KALEX, LLC, Belmont, CA (US)

(21) Appl. No.: 12/688,224

(22) Filed: Jan. 15, 2010

(51) Int. Cl. F24J 2/04; F03G 6/02

(52) U.S. Cl. 126/640; 60/641.13

(57) ABSTRACT

Solar-thermal energy storage systems and methods are disclosed including a heat transfer fluid storage and distribution subsystem (HTFSDSS) including at least N storage tanks, control valves, and transfer lines, a solar heating or collector subsystem (SHSS) connected to the HTFSDSS via the transfer lines, and a heat conversion or power subsystem (HCSS) connected to the HTFSDSS via the transfer lines, where at least one of the N tanks is empty at the start of an operational cycle and heat transfer fluid is forwarded from filled tanks in the HTFSDSS through the other subsystem and into the empty tank or tanks.

### BACKGROUND OF THE INVENTION

1. Field of the Invention

Embodiments of the present invention relates to solar power generation systems for converting thermal energy into a useable form of energy, where the thermal energy is derived from storing thermal energy in the form of a hot heat transfer fluids (HTF), which is heated by solar radiation and the systems utilize a tanks to the store the hot HTF, where one of the tanks is empty at the start or completion of an operation or thermal cycle.

More particularly, embodiments of the present invention relates to solar power generation systems for storing thermal energy in the form of hot transfer (HTF) and for converting a potion of the stored thermal energy into a useable form of energy, where the stored thermal energy is derived from a stored hot heat transfer fluid (HTF), which is heated by solar radiation. The system includes a solar heating subsystem (SHSS), a heat conversion subsystem (HCSS) and a heat transfer fluid storage and distribution subsystem (HTFSDSS), where the HTFSDSS includes at least three tanks, one of which is empty at the start or completion of an operational or thermal cycle.

2. Description of the Related Art

Conventional systems for storing thermal energy in the form of hot HTF usually consist of two or more tanks, but always in groups of two. One tank (or one set of tanks) is devoted to the storage of hot liquid, which has been heated in a solar collector (or by other means) and the other for the storage of cooled HTF after it has transferred its heat to the working fluid of a power system.

Because cooled HTF has a slightly lower volume than hot HTF, the tank(s) for the storage of cooled HTF is usually slightly smaller than the tank(s) for storing hot HTF. Nevertheless, the overall volume of the storage tanks is almost twice as large as the maximum volume of HTF that is stored in the system.

Thus, there is a need in the art for a system capable of substantially reducing total volume of storage tanks.

### SUMMARY OF THE INVENTION

Embodiments of the present invention provide a solar power generation system including a solar heating subsystem (SHSS), a heat conversion subsystem (HCSS) and a heat transfer fluid storage and distribution subsystem (HTFSDSS). The HTFSDSS includes N tanks, valves, valve controllers and a control unit, where at least one of the N tanks is empty at the start and completion of an operation cycle. The HTFSDSS is also adapted to store hot and cold heat transfer fluid and distribute the fluid to the other subsystems. The SHSS heats cold heat transfer fluid transferred from one of the N-M tanks of the HTFSDSS filled with cold heat transfer fluid to form hot heat transfer fluid, which is transferred to an empty tank of the HTFSDSS. This process is continued until N-M tanks of the HTFSDSS are filled with hot heat transfer fluid. The HCSS converts a portion of the thermal energy stored in the hot heat transfer fluid transferred from the N-M tanks of the HTFSDSS filled with hot heat transfer fluid to form cold heat transfer fluid, which is transferred to the empty tank or tanks of the HTFSDSS. The process is continued until N-M of the tanks of the HTFSDSS are filled with cold heat transfer fluid. The system is designed to operate on an operational cycle. The operational cycle occurs when (1) all the cold heat transfer fluid in N-M tanks of the HTFSDSS are transferred to the SHSS and heated to hot heat transfer fluid and stored in N-M tanks of the HTFSDSS and (2) all hot transfer fluid in the N-M tanks of the HTFSDSS are transferred to the HCSS, where a portion of the heat in the hot heat transfer fluid is transferred to a working fluid of the HCSS to form cold heat transfer fluid and stored in N-M tanks of the HTFSDSS, where N is an integer greater than 3 and M is an integer less than N. In certain embodiments, N is an integer between 1 and 30 and M is an integer between 1 and 5.

Embodiments of the present invention provide a heat transfer fluid storage and distribution subsystem (HTFSDSS) for storing and distributing cold heat transfer fluid and hot heat transfer fluid. The HTFSDSS includes N tanks, valves, valve controllers and a control unit, where at least one of the N tanks is empty at the start and completion of an operation cycle. The HTFSDSS is also adapted to distribute the cold or hot heat transfer fluid to and from the other subsystems. The control unit of the HTFSDSS is adapted to set the valve through valve controllers to create flow paths from one or more filled tanks to one or more empty tanks through the other subsystems. The setting of the valves permits flow paths between tanks of the HTFSDSS and the other two subsystems. The setting of the valves permits the operational cycle to be completed by setting valves to produce flow paths so that HTF from all filled tanks can be sent through either the SHSS or the HCSS and into the empty tank or tanks.

Embodiments of this invention provide a solar power system including a heat transfer fluid storage and distribution subsystem (HTFSDSS) including N storage tanks, M empty storage tanks, control valves, and transfer lines, where the HTFSDSS stores and distributes cold heat transfer fluid or hot heat transfer fluid. The system also includes a solar heating or collector subsystem (SHSS) connected to the HTFSDSS via the transfer lines, where the SHSS heats cold heat transfer fluid to produce hot heat transfer fluid. The system also includes a heat conversion or power subsystem (HCSS) connected to the HTFSDSS via the transfer lines, where the HCSS transfers a portion of thermal energy or heat from the hot heat transfer fluid to a working fluid and converts a portion of the heat in the working fluid to a useable form or energy to produce cold heat transfer fluid. N is an integer having a value greater than or equal to 3. M is an integer having a value less than N. The HTFSDSS opens flow paths for transferring heat transfer fluid from L filled tanks through either the SHSS or the HCSS and where L is an integer having a value less than or equal to M. In certain embodiments, N has a value between 3 and 20, M has a value between 1 and 3, and L has a value between 1 and 3. In other embodiments, N has a value between 3 and 20, M has a value between 1 and 3, and L is equal to M. In other embodiments, N has a value between 3 and 20 and M is 1 and L is 1. In other embodiments, N has a value between 4 and 20, and M and L are 2. In other embodiments, N has a value between 6 and 18, and M and L are 3.

Embodiments of this invention provide a method including sequentially creating a flow path between L tanks of a heat transfer fluid storage and distribution subsystem (HTFSDSS) including N storage tanks, M empty storage tanks, control valves, and transfer lines through the transfer lines to a solar heating or collector subsystem (SHSS). The method also includes sequentially transferring cold heat transfer fluid (cHTF) from L tanks filled with the cHTF through the SHSS, where the SHSS heats the cHTF to form hHTF. The method also includes storing the hHTF in L empty tanks of the HTFSDSS. The method also includes continuing the previous three steps until N-M tanks filled with cHTF are filled with N-M tanks of hHTF. The method can also include sequentially creating a flow path between L tanks of the HTFSDSS through the transfer lines to a heat conversion or power subsystem (HCSS). The method can also include sequentially transferring the hHTF from L tanks filled with hHTF through the HCSS, where the HCSS transfers a portion of heat or thermal energy from the hHTF to a working fluid of the HCSS and cools the hHTF to form cHTF. The method can also include storing the hHTF in L empty tanks of the HTFSDSS. The method can also include continuing previously three steps until all of the hHTF is cooled to cHTF. In certain embodiments, N has a value between 3 and 20, M has a value between 1 and 3, and L has a value between 1 and 3. In other embodiments, N has a value between 3 and 20, M has a value between 1 and 3, and L is equal to M. In other embodiments, N has a value between 3 and 20 and M is 1 and L is 1. In other embodiments, N has a value between 4 and 20, and M and L are 2. In other embodiments, N has a value between 6 and 18, and M and L are 3. The methods can also include repeating all of the steps on a periodic basis. In certain embodiments, the period is daily.

Embodiments of this invention provide a method including heating cold heat transfer fluid (cHTF) stored in N-M tanks of a heat transfer fluid storage and distribution subsystem (HTFSDSS) including N storage tanks, M empty storage tanks, control valves, and transfer lines in a solar heating or collector subsystem (SHSS) to form hot heat transfer fluid (hHTF). The method also includes storing the hHTF in N-M tanks of the HTFSDSS. The method also includes transferring a portion of heat from hHTF stored in N-M tanks HTFSDSS to a working fluid of a heat conversion or power subsystem (HCSS) to form cHTF. The methods also includes storing the cHTF in N-M tanks of the HTFSDSS. In certain embodiments, N has a value between 3 and 20, M has a value between 1 and 3, and L has a value between 1 and 3. In other embodiments, N has a value between 3 and 20, M has a value between 1 and 3, and L is equal to M. In other embodiments, N has a value between 3 and 20 and M is 1 and L is 1. In other embodiments, N has a value between 4 and 20, and M and L are 2. In other embodiments, N has a value between 6 and 18, and M and L are 3. The methods can also include repeating all of the steps on a periodic basis. In certain embodiments, the period is daily.

### BRIEF DESCRIPTION OF THE DRAWINGS

The invention can be better understood with reference to the following detailed description together with the appended illustrative drawings in which like elements are numbered the same:

FIG. 1A depicts an embodiment of a generalized system of this invention.

FIG. 1B depicts an embodiment of a HTFSDSS of this invention.

FIG. 1C depicts another embodiment of a HTFSDSS of this invention.

FIG. 1D depicts another embodiment of a HTFSDSS of this invention.

FIG. 1E depicts another embodiment of a HTFSDSS of this invention.

FIG. 2A depicts an embodiment of a system of this invention including three tanks.

FIGS. 2B-I depict a complete operational cycle of the system of FIG. 2A.

FIG. 3 depicts an embodiment of a system of this invention including four tanks.

FIG. 4 depicts an embodiment of a system of this invention including five tanks.

FIG. 5A depicts an embodiment of a system of this invention including six tanks.

FIGS. 5B-D depict a partial operational cycle of the system of FIG. 5A.

### DETAILED DESCRIPTION OF THE INVENTION

The inventor has found that a solar power system can be constructed including a heat transfer fluid storage and distribution subsystem designed to reduce the number of tanks and to efficiently use the tanks for the storage and distribution of heat transfer fluid to and between a solar heating subsystem and a heat conversion subsystem. The heat transfer fluid storage and distribution subsystem including N tanks. The heat transfer fluid storage and distribution subsystem is designed to transferred cold heat transfer fluid to the solar heating subsystem from N-M full tanks, where the cold heat transfer fluid is heated to form hot heat transfer fluid, which is then stored in N-M tanks. The heat transfer fluid storage and distribution subsystem is also designed to transferred hot heat transfer fluid from the N-M tanks through the heat conversion subsystem, where a portion of the heat in the hot heat transfer fluid is transferred to a working fluid of the heat conversion subsystem to form cold heat transfer fluid, which is then stored in N-M tanks. N and M are integers. N has a value greater than or equal to 3. In certain embodiments, M has a value of 1. In other embodiments, M has a value of 2. In other embodiments, M has a value of 3. In embodiments where M is greater than 1, heat transfer fluid from M filled tanks in the heat transfer fluid storage and distribution subsystem is transferred to the solar heating subsystem of the heat conversion subsystem to increase fluid throughput.

Embodiments of the present invention relate to solar power systems including a heat transfer fluid storage and distribution subsystem (HTFSDSS) including N heat transfer fluid storage tanks, fluid conduits, control valves, and a control unit, where N is an integer having a value greater than or equal to three, so that at a start or completion of an operational or thermal cycle, one of the N tanks is empty and N-M tanks are filled with either cold or hot heat transfer fluid. The system also includes a solar heating or collector subsystem (SHSS) (or other heating subsystem), where cold heat transfer fluid (cHTF) transferred from N-M tanks of the HTFSDSS is heated to form hot heat transfer fluid (hHTF), which is then stored in N-M tanks of the HTFSDSS. The system also includes a heat conversion or power subsystem (HCSS), where the hHTF transferred from the N-M tanks of the HTFSDSS is cooled, transferring a portion of its heat to a working fluid of the HCSS, which in turn is used in the HCSS to produce electric power to form the cHTF, which is then stored in N-M tanks of the HTFSDSS. N and M have the values as set forth above.

Embodiments of the present invention relate to method operating a solar power system including sequentially transferring cold heat transfer fluid (cHTF) from N-M tanks of a heat transfer fluid storage and distribution subsystem (HTFSDSS) to a solar heating or collector subsystem (SHSS) (or other heating subsystem). The method also includes sequentially heating the cHTF in the SHSS from the N-M tanks to form hot heat transfer fluid (hHTF). The method also include sequentially transferring the hHTF from the SHSS to N-M tanks of the HTFSDSS. The method also includes sequentially transferring hHTF from N-M tanks of the HTFSDSS to a heat conversion or power subsystem (HCSS). The method also include sequentially transferring a portion of heat in the hHTF to a working fluid of the HCSS to form cHTF. The method also includes sequentially transferring cHTF from the HCSS to N-M tanks of the HTFSDSS. The HFTSDSS is designed so that one volume of its N tanks is always empty so that fluid is transferred through either the SHSS and HCSS including N heat transfer fluid storage tanks, fluid conduits, control valves, and a control unit, where N is an integer having a value greater than or equal to three, so that at a start or completion of an operational or thermal cycle, one of the N tanks is empty and N-M tanks are filled with either cold or hot heat transfer fluid. The system also includes a solar heating or collector subsystem (SHSS) (or other heating subsystem), where cold heat transfer fluid (cHTF) transferred from N-M tanks of the HTFSDSS is heated to form hot heat transfer fluid (hHTF), which is then stored in N-M tanks of the HTFSDSS. N and M are integers and have the values as set forth above.

The method of this invention including performing a thermal cycle including heating a cold heat transfer fluid from N-M filled tanks of a heat transfer fluid storage and distribution subsystem in a solar heating subsystem to form hot heat transfer fluid and storing the hot heat transfer fluid into N-M tanks, where at the start of the cycle N tanks are filled with heat transfer fluid and M tanks are empty. The method also includes transferring a portion of the thermal energy in the hot heat transfer fluid stored in the N-M filled tanks of the heat transfer fluid storage and distribution subsystem to a working fluid of a heating conversion or power subsystem and storing the cold heat transfer fluid in N-M tanks. The method is repeated daily during system operation.

### Suitable Reagents and Equipment

Suitable heat transfer fluids for use in this invention include, without limitation, meltable salts, synthetic heat transfer fluids such as THERMINOL® (a registered trademark of Solutia Inc. Corporation) and DOWTHERM® (a registered trademark of Dow Chemicals Corporation), natural heat transfer fluids, other fluids capable of acting as a heat transfer fluid, and mixtures or combinations thereof.

Suitable working fluids for use in the HCSS include, without limitation, a multi-component working fluid including at least one lower boiling component and at least one higher boiling component. In certain embodiments, the working fluids include an ammonia-water mixture, a mixture of two or more hydrocarbons, a mixture of two or more freon, a mixture of hydrocarbons and freon, or the like. In general, the fluid can comprise mixtures of any number of compounds with favorable thermodynamic characteristics and solubility. In certain embodiments, the fluid comprises a mixture of water and ammonia.

Suitable tanks for use in the invention include, without limitation, any storage vessel amenable to storage of a heat transfer fluid.

Suitable valves for use in the invention include, without limitation, any valve capable of opening and closing to allow fluid to flow in or out of a tank.

Suitable valve controllers for use in the invention include, without limitation, any valve controller capable of opening and closing a valve.

Suitable control units for use in the invention include, without limitation, any computer or manual unit for controlling a set of valve controllers to create appropriate fluid paths for the transfer of fluid between subsystems.

### DETAILED DESCRIPTION OF THE DRAWINGS

### Generalized Embodiment

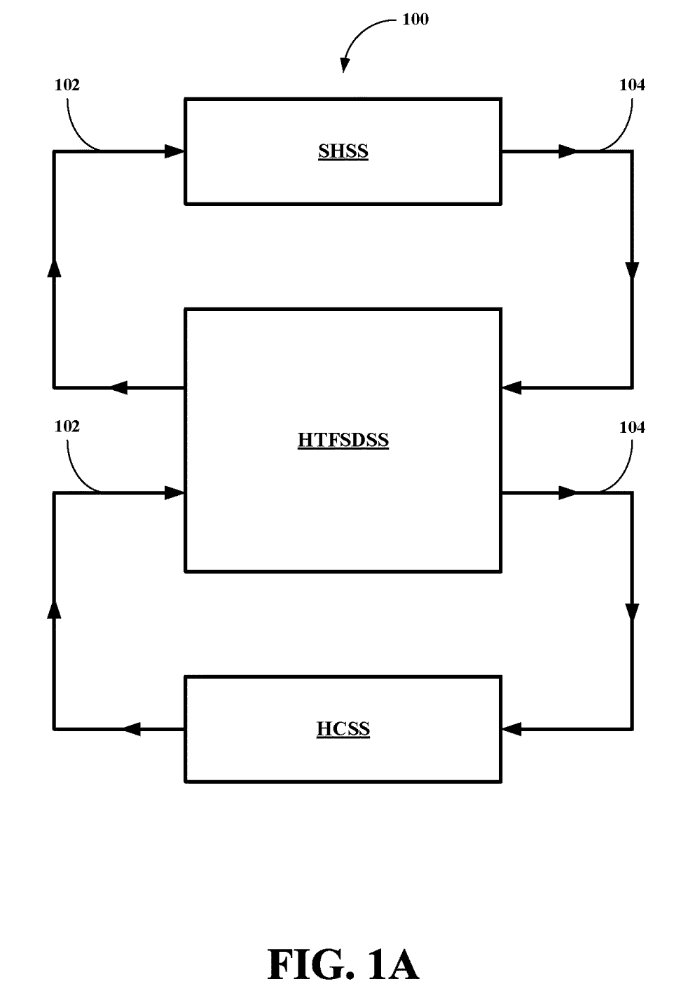

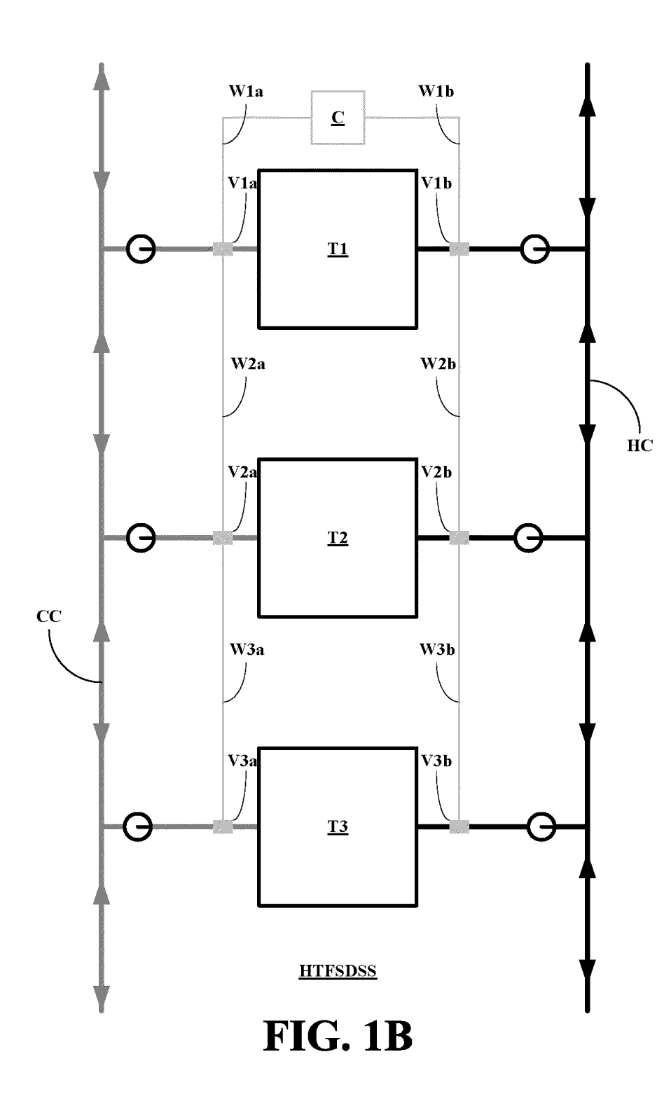

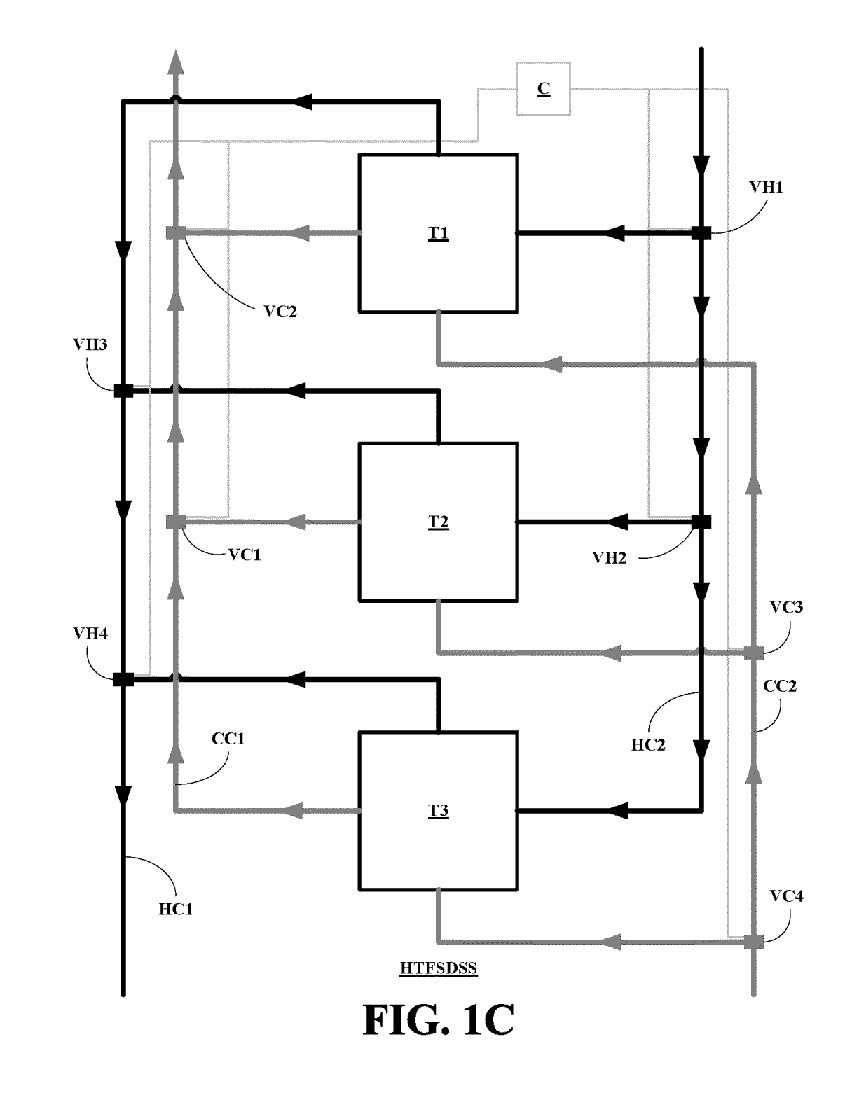

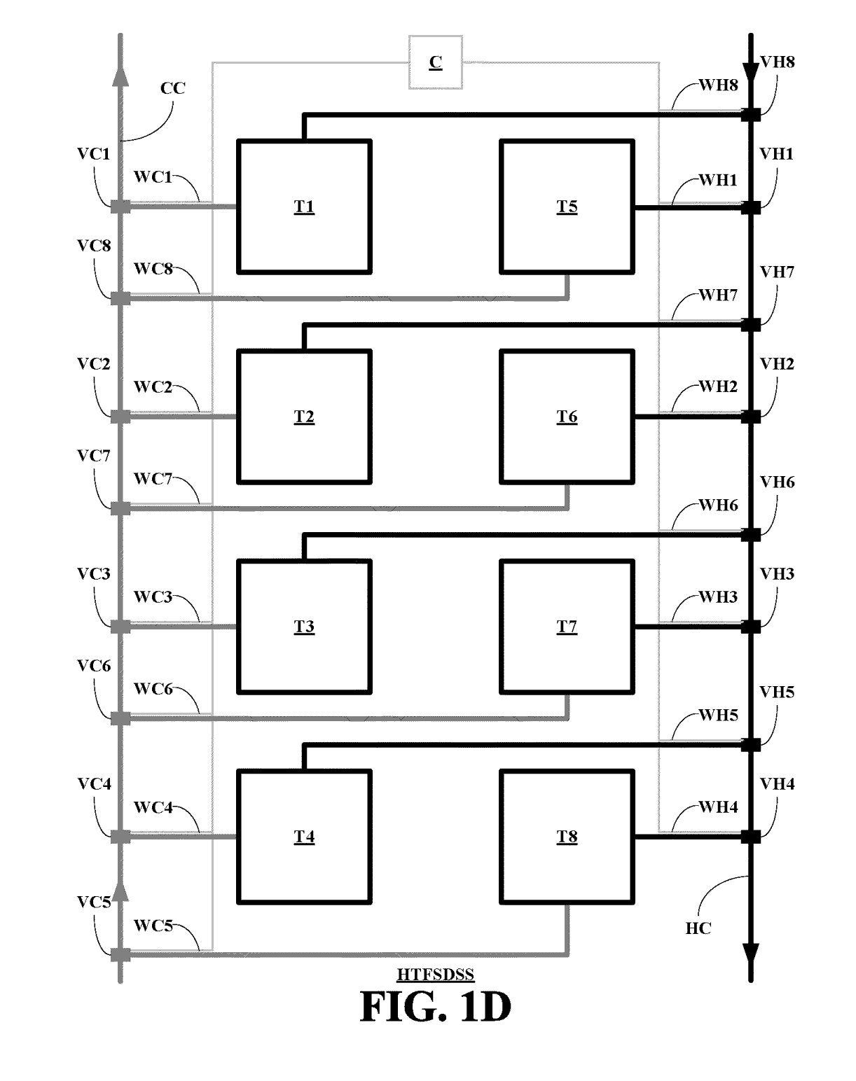

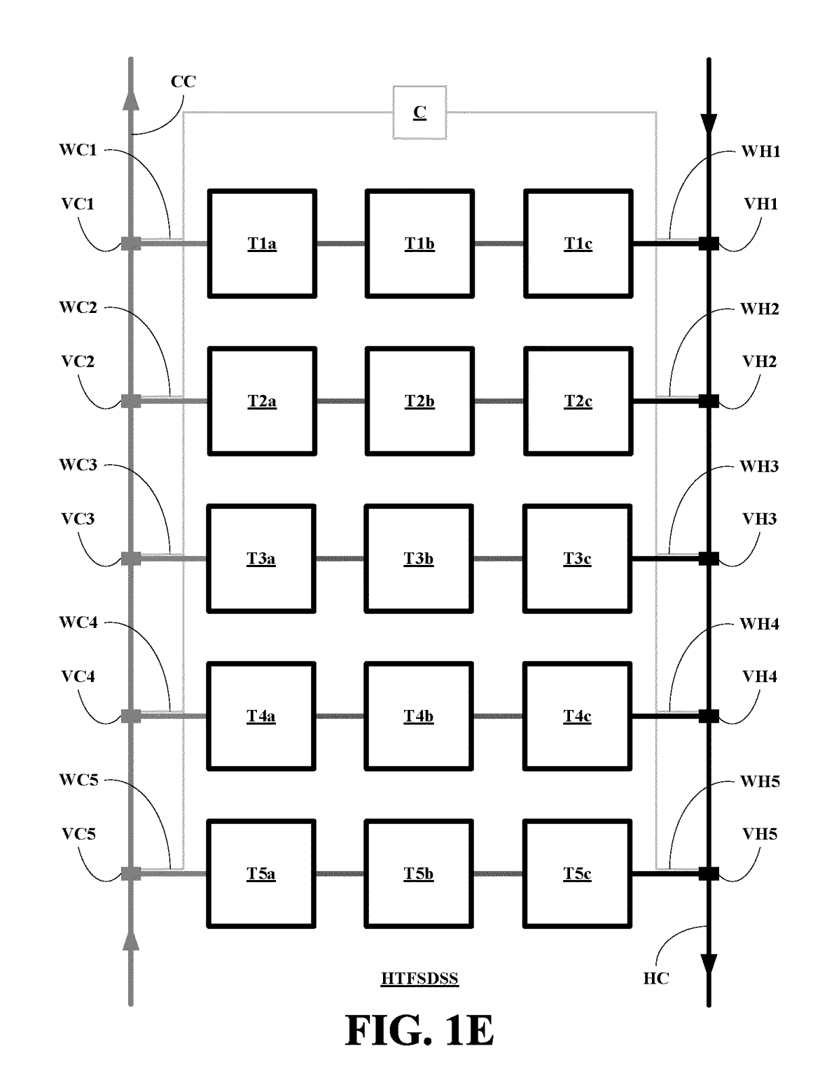

Referring now to FIG. 1A, an embodiment of the present solar power system, generally 100, is shown. The system 100 includes a solar heating subsystem SHSS, a heat transfer fluid storage and distribution subsystem HTFSDSS and a heat conversion subsystem HCSS. The HTFSDSS comprises at least three tanks, fluid conduits to the other subsystems and valve for directly cHTF and hHTF into and out of the tanks to the other subsystems. When no fluid is being transferred from the HTFSDSS to the other subsystems, at least one of the tanks in the HTFSDSS is empty. In this way, HTF can be circulated through the subsystems without the need for auxiliary storage tanks, minimizing the number of tanks, minimizing the volume of tanks, and maximizing tank utility. The HTFSDSS includes valving and pumps adapted to sequentially transfer cold heat transfer fluid (cHTF) 102 from a full tanks to the SHSS, where the cHTF 102 is heated using solar energy to produce a hot heat transfer fluid (hHTF) 104. The hHTF 104 is then transferred back to the HTFSDSS, where the hHTF 104 is stored sequentially into an empty storage tank. In this process, the tank from which the cHTF is removed becomes empty and an empty tank becomes full of hHTF. The HTFSDSS then transfers the hHTF 104 sequentially from a full tank to the HCSS, where a portion of its thermal energy is converted into a useable form of energy producing a cHFT 102. The cHFT 102 is then returned to the HTFSDSS to an empty tank. Again, in this process, the hHTF is removed sequentially from full tanks, while the cHTF is returned sequentially to empty tanks. Thus, the HTFSDSS always has at least one empty, when no HTF is being transferred. or When HTF is being transferred, then HTF is being removed from a full tank and transferred to the empty tank, converting the full tank to an empty tank and the empty tank to a full tank. This processes is continued until cHTF filled tanks are converted to filled hHTF or until filled hHTF tanks are converted to filled cHTF depending on the stage of a storage cycle. During the day, cHTF is heated and stored as hHTF; during the night, a portion of the heat from the stored hHTF is converted into useable energy and the resulting cHTF is stored completing a cycle; and the cycle is repeated. Of course, during the day, the solar collectors can also be used to supply hot heat transfer fluid directly to the HCSS, while simultaneously heating the cHTF stored in the HTFSDSS.

### Generalized HTFSDSS Embodiments

Referring now to FIG. 1B, an embodiment of the HTFSDSS of this invention is shown to include three tanks T1, T2, and T3. The HTFSDSS also includes six valves V1a&b, V2a&b and V3a&b, two per tank. The valves V1a&b, V2a&b and V3a&b are connected to a control unit C, via wires W1a&b, W2a&b and W3a&b. The HTFSDSS may also include six pump P1a&b, P2a&b, and P3a&b controlled by the control unit C. The HTFSDSS also includes cold heat transfer fluid conduits CC (grey) and hot heat transfer fluid conduits HC (black). The control unit C opens and closes the valves and turns on pumps to produce a flow path between a full tank and an empty tank. For example, if fluid is to flow from tank T1 to tank T3, then valves V1a and V3b are opened and all of the other valves are closed and pump P1a is turned on. The control unit C opens and closes valves during the heating cycle until all N-M tanks filled with cHTF have been heated to fill N-M tanks with hHTF. The control unit C repeats the opening and closing of valves and turn on and off of pumps until all of the heat transfer fluid has either been cycled through the SHSS or HCSS. If the HTFSDSS includes four or more tanks and 2 or more are empty at the start of a cycle, then the control unit opens valves so that fluid flows from M tanks simultaneously provided that the SHSS and HCSS can accommodate the flow rate. It should be recognized that the system can operate with pumps in the SHSS and HCSS obviating the need for pumps in the HTFSDSS. Such arrangements minimize the number of types of pumps needed.

Referring now to FIG. 1C, another embodiment of the HTFSDSS of this invention is shown to include three tanks T1, T2, and T3. The HTFSDSS also includes cold heat transfer fluid conduits CC1&2 and hot heat transfer fluid conduits HC1&2. The HTFSDSS also includes eight valves VC1&2, VC3&4, VH1&2 and VH3&4, all of the valves are three ways valves. The VC1&2 valves control the flow of cHTF to the SHSS, while the VC3&4 valves control the flow of cHTF from the HCSS. The VH1&2 valves control the flow of hHTF from the SHSS, while the VH3&4 valves control the flow of hHTF to the HCSS. All eights valves VC1-4 and VH1-4 are connected to a control unit C, via wires WC1&2 and WH1&2. The control unit C opens and closes the valves to create flow paths between a full tank and an empty tank through either the SHSS or the HCSS. For example, if fluid is to flow from tank T1 to tank T3 through the SHSS, then valves VC1 and VH1 set to allow fluid to flow through the SHSS from T1 to T3. The control unit C sets the valves so that during the heating cycle, the N-M cHTF filled tanks are heated in the SHSS to yield N-M hHTF filled tanks. The control unit C preforms a similar operation during the night cycle so that the N-M hHFT filled tanks are cooled in the HCSS to yield N-M cHTF fille tanks. The control unit C repeats valve setting operation during each full cycle.

Referring now to FIG. 1D, another embodiment of the HTFSDSS of this invention is shown to include eight tanks T1-8. The HTFSDSS also includes cold heat transfer fluid conduits CC and hot heat transfer fluid conduits HC. The HTFSDSS also includes eight cHTF valves VC1-8 and eight hHTF valves VH1-8, all of the valves are three ways valves. The HTFSDSS also includes a control unit C connected to the valves VC1-8 via wires WC1-8 and the valves VH1-8 via wires WH1-8, which allows the control unit C to control the configuration of the three ways valves to produce desire flow paths for HTF to flow through either the SHSS or HCSS. The HTFSSDSS of this embodiment can function is a number of different procedures. One set of procedures would operate if four of the tanks were full and four of the tanks were empty at the start of a cycle. For example, if tanks T1-4 were initially filled with cHTF and tanks T5-8 were initially empty, then the procedures would operate to set one or more of valves VC1-4 to open flow paths from their corresponding tanks T1-4 through the CC conduits into the SHSS so that cHTF is heated in the SHSS and set one or more of the valves VH1-4 to open flow paths to their corresponding tanks T5-8 through the HC conduits from the SHSS so that hNTF is stored during the heating cycle. This set of procedures would differ depending on the heating capacity of the SHSS. Thus, this set of procedures could sequentially establish flow paths from T1 to T5, T2 to T6, T3 to T7 and T4 to T8, or establish flow paths from T1 and T2 to T5 and T6, or establish flow paths from T1-3 and T5-7 or establish flow paths from T1-4 and T5-8. Alternatively, M tanks are initially empty, while N-M tanks are full, where M is 1, 2 or 3. The procedures associated with this design operates by setting valves so that HTF flows from 1 to M full tanks to the empty tanks through either the SHSS or the HCSS. The process is repeated sequentially until all HTF from the full tanks have been passed through either the SHSS or HSCC.

Referring now to FIG. 1E, another embodiment of the HTFSDSS of this invention is shown to include 15 tanks T1a-c, T2a-c, T3a-c, T4a-c, and T5a-c. The HTFSDSS also includes cold heat transfer fluid conduits CC and hot heat transfer fluid conduits HC. The HTFSDSS also includes five cHTF valves VC1-5 and five hHTF valves VH1-5, all of the valves are three ways valves. The HTFSDSS also includes a control unit C connected to the valves VC1-5 via wires WC1-5 and the valves VH1-5 via wires WH1-5, which allows the control unit C to control the configuration of the three ways valves to produce desire flow paths of HTF through either the SHSS or HCSS. The HTFSDSS also includes cold heat transfer fluid conduits CC and hot heat transfer fluid conduits HC. This embodiment is designed with five set of three coupled tanks. Each set of coupled tanks, for the sake of fluid flow, acts as a single tank, but as smaller tanks are often easier to insulate, this embodiments uses smaller better insulate tanks. At the start or completion of a cycle, one or two sets of couples tanks is empty. The control unit C then sets the valves so that HTF flow from full sets to empty sets through either the SHSS or the HCSS depending on whether the cycle is heating or heat extraction and cooling. Again, N is the total number of sets, N-M sets are full and M sets are empty, where N is five and M is 1 or 2, but for other values of N, M could be larger.

### Three Tank Embodiment

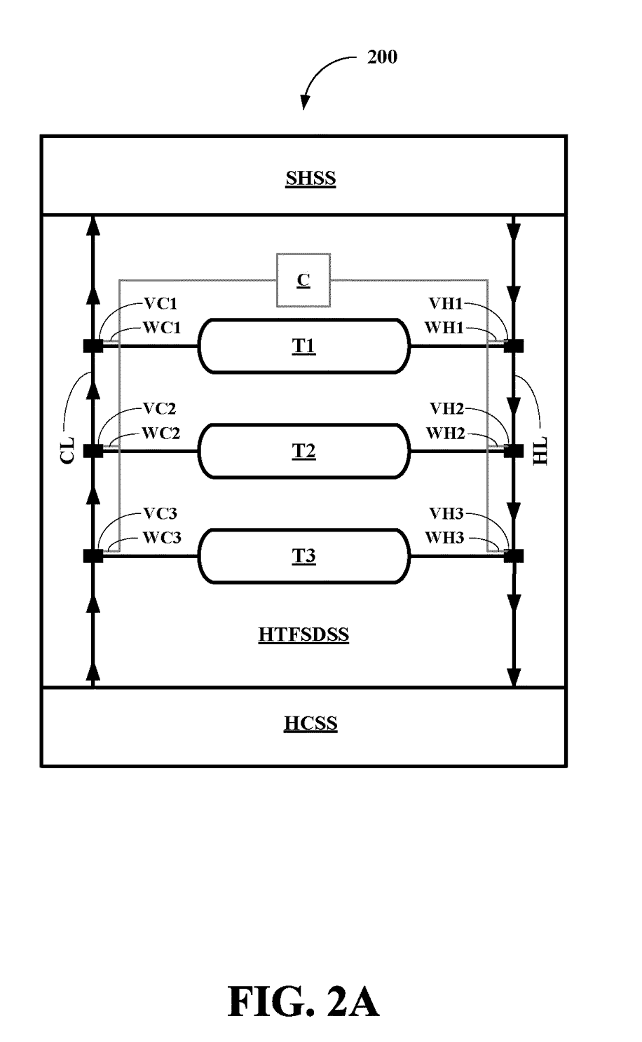

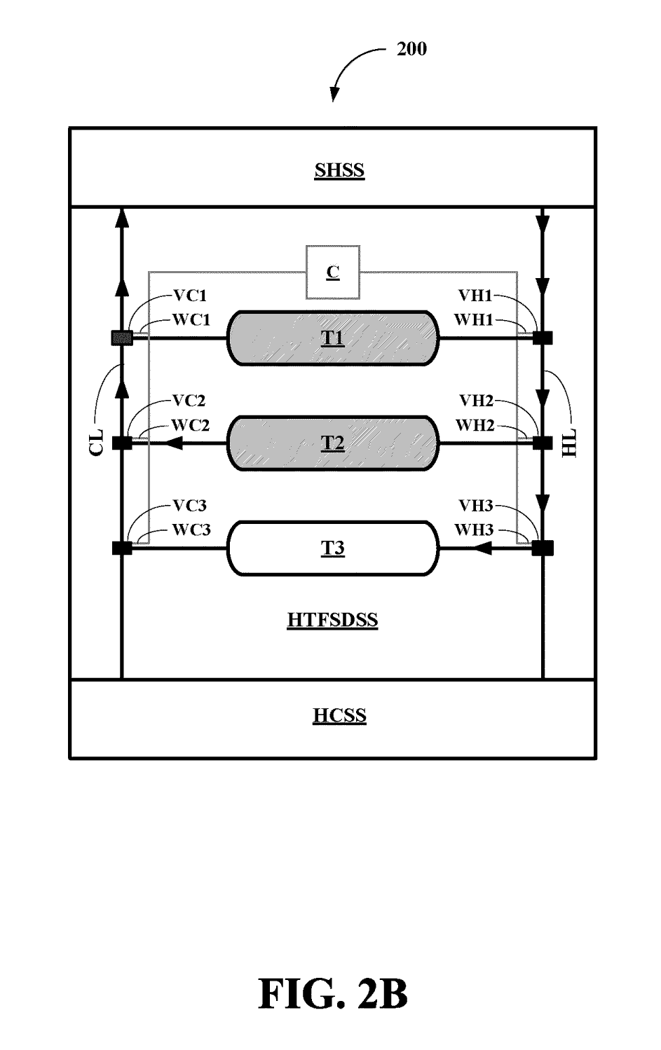

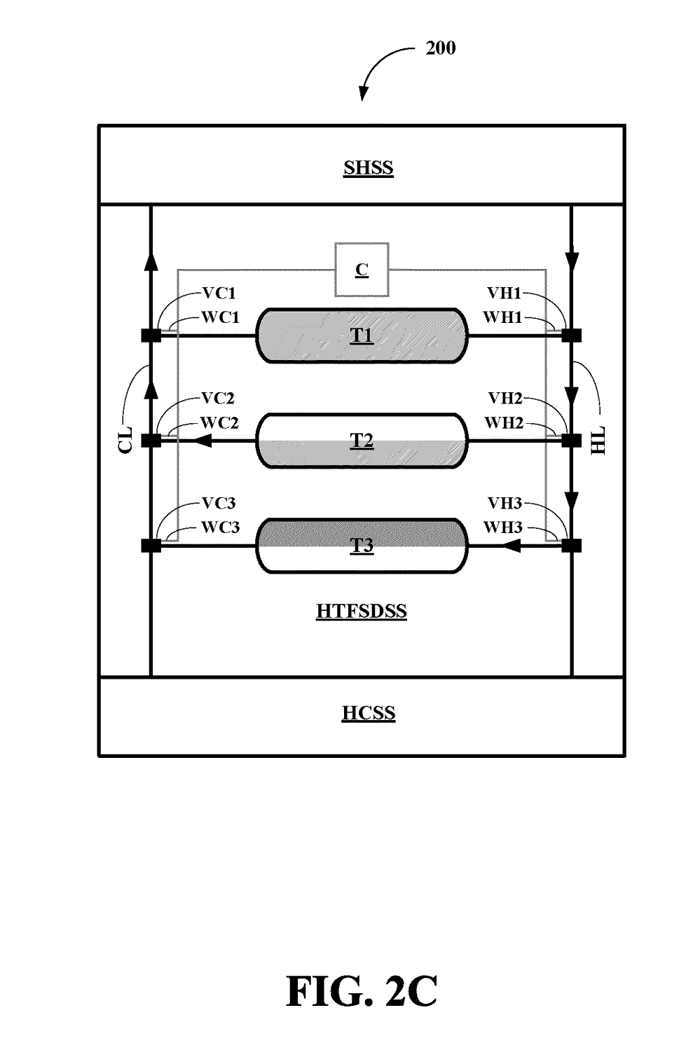

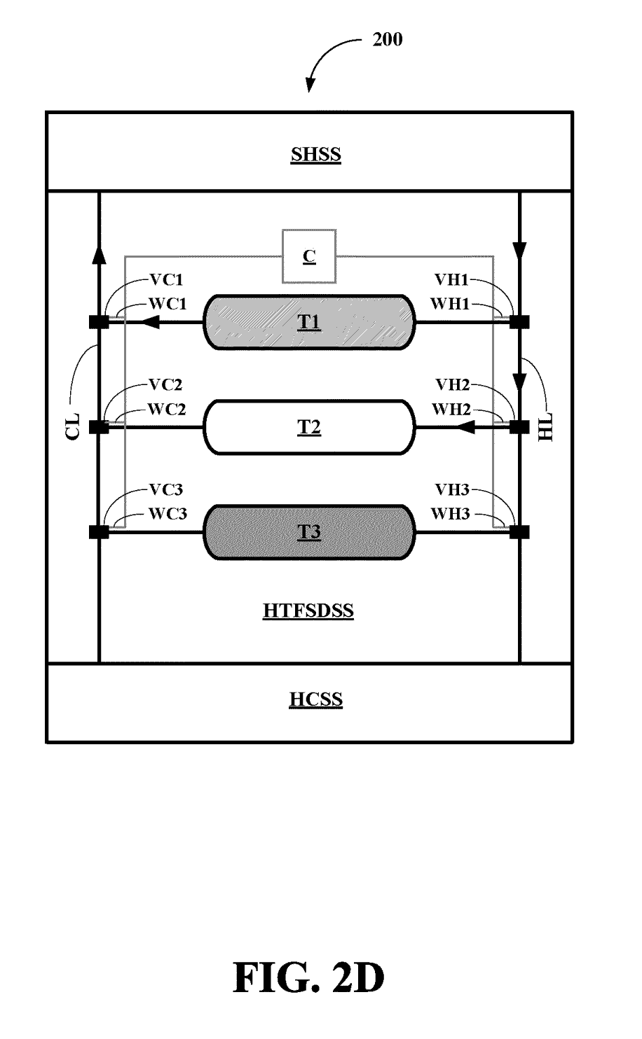

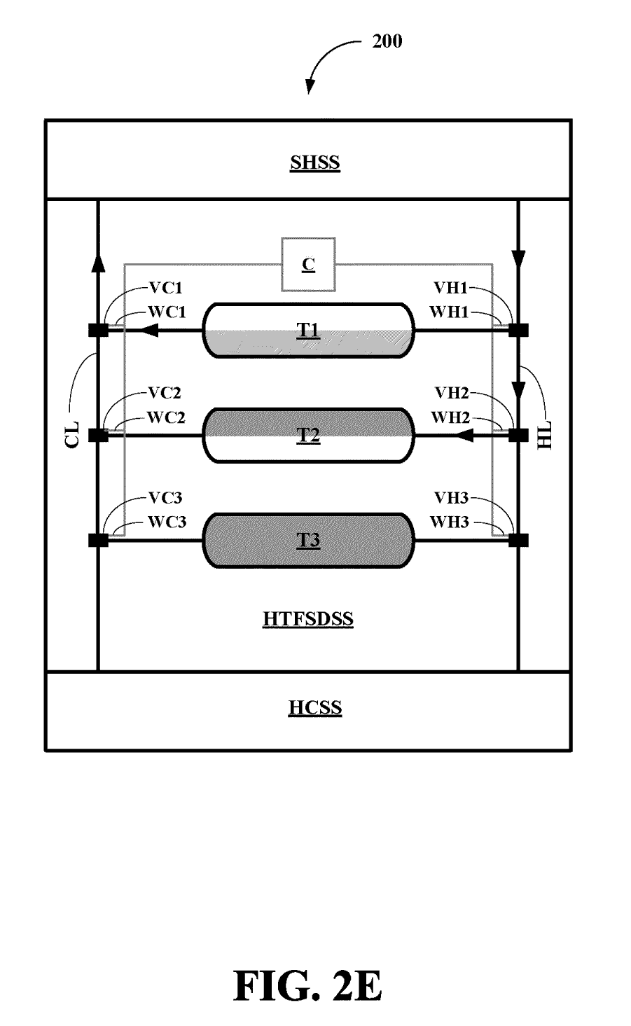

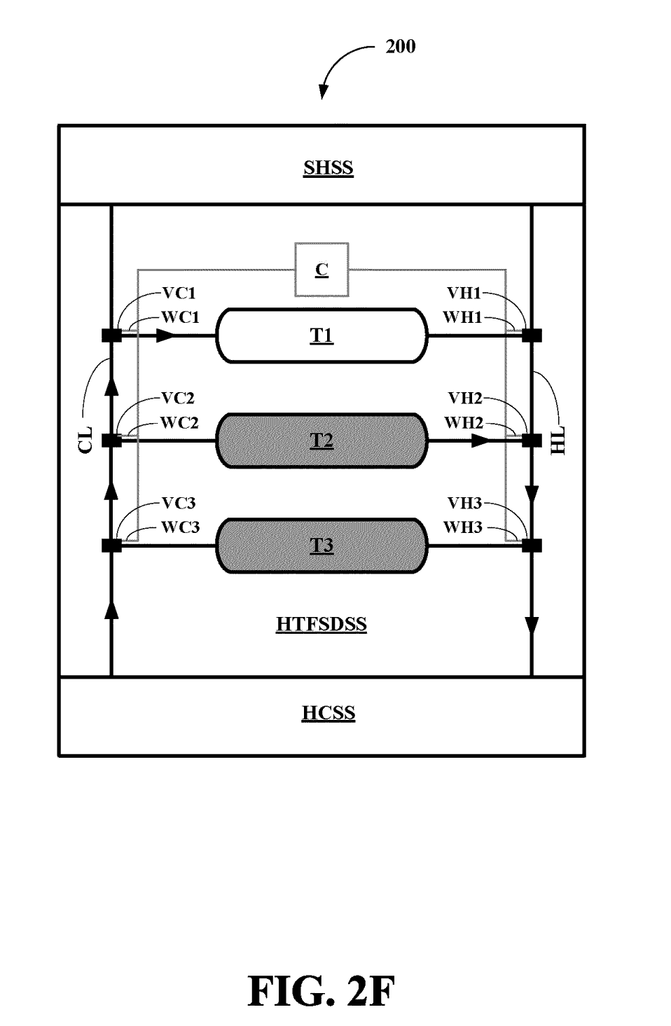

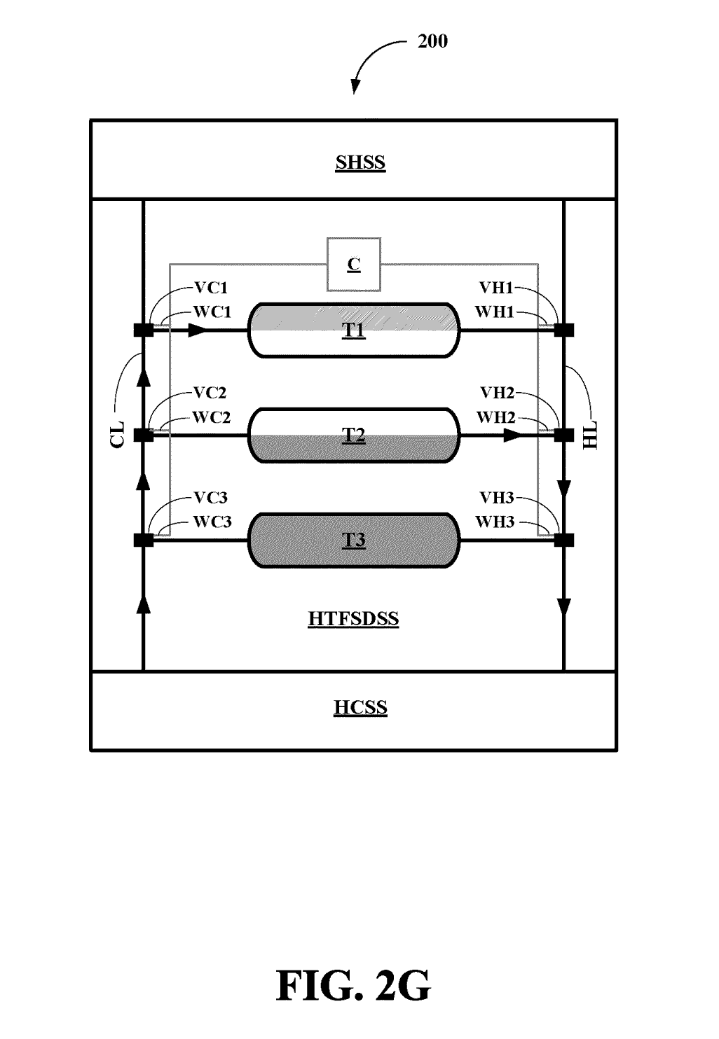

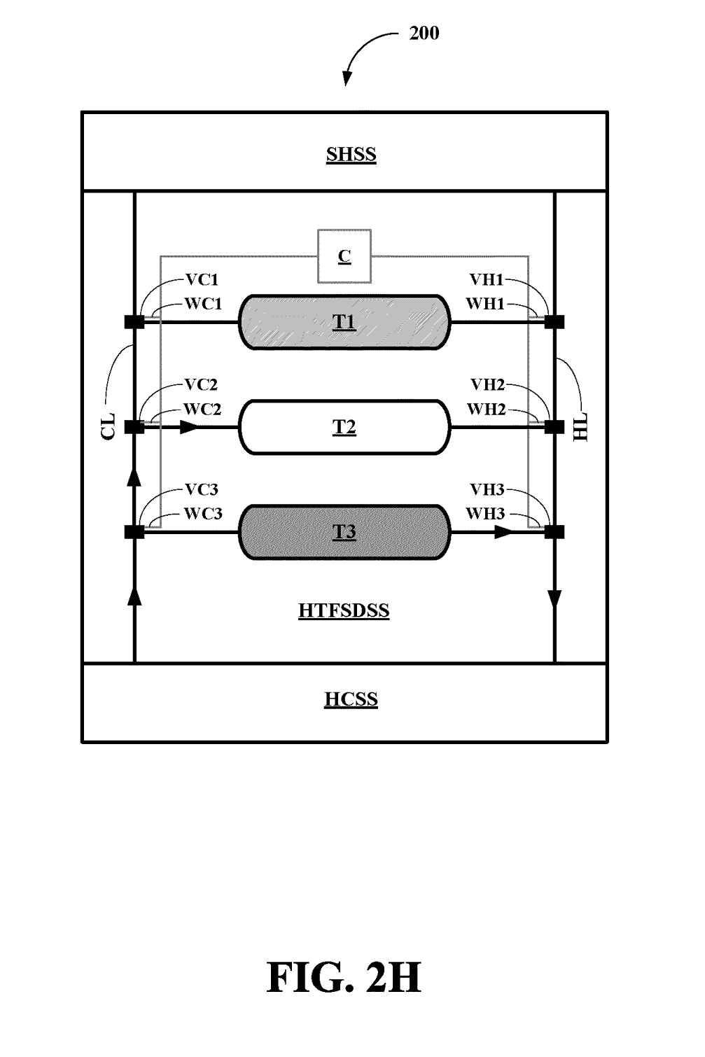

Referring now to FIG. 2A, an embodiment of the present solar power system, generally 200, is shown. The system 200 includes a solar heating subsystem SHSS, a heat transfer fluid storage and distribution subsystem HTFSDSS and a heat conversion subsystem HCSS. The HTFSDSS includes three heat fluid storage tanks T1, T2 and T3, a cold HTF transfer line CL, a hot HTF transfer line HL and six valves VC1-3 and VH1-3 associated with the CL and the HL, respectively. The six valves in this embodiment are all three way valves. The HTFSDSS also includes a control unit C connected to each of the valves VC1-3 and VH1-3 via wires WC1-3 and WH1-3, respectively, for controlling the valves VC1-3 and VH1-3 to produce desires fluid flow paths between the HTFSDSS and the SHSS or the HCSS. In this embodiment, the HTFSDSS include one empty tank and two filled tanks at a start of a cycle or a half cycle. The filled tanks will either include cold heat transfer fluid (cHTF) or hot heat transfer fluid (hHTF) depending on point within the cycle. The SHSS heats cHTF using solar energy to produce hHTF. The hHTF is transferred to the HTFSDSS, where the hHTF is stored in one or a plurality of empty storage tanks. The hHTF is then transferred to the HCSS, where a portion of the heat of the hHTF is transferred to a working fluid used ultimately to produce a useful form of power. cHFT exiting the HCSS is then stored in empty storage tanks of the HTFSDSS.

The HTFSDSS is connected to the SHSS and to the HCSS via a cHTF pipe or pipeline CL and a hHFT pipe or pipeline HL. Each of the storage tanks T1-3 is, in its turn, connected to both of these lines. The system operates as follows.

When the system is fully discharge, then tanks T1-2 are filled with cHTF and tank T3 is empty. It should be recognized that the exact tank that is empty is not relevant. All that is required is that a single tank be empty and the control unit know which tank is empty.

At the beginning of system operations, cHTF from tank T2 is sent through the CL into the SHSS, where the cHTF it is heated to produce hHTF. The hHTF is then sent through the HL into tank T3, the initially empty tank. The transfer of cHTF from the tank T2 to be heated in the SHSS continues until the tank T2 is emptied of cHTF and the tank T3 is filled with hHTF. In the transfer process, the full tank T2 is emptied becoming the empty tank, and the empty tank T3 is filled becoming a full tank.

Thereafter, cHTF from the full tank T1 is transferred through the CL to the SHSS, where it is heated to produce hHTF. The hHTF from the tank T1 is transferred through the HL to the tank T2, which was previously emptied. Again the HTF transfer process continues until the tank T2 is full of hNTF and the tank T1 is empty.

This transfer process is then repeated, with cHTF from the tank T3 heated and stored in the now empty tank T4, and so on, till cHTF in the tank T1 is heated and stored in the tank T2.

As a result, all cHTF in the system is now hHTF and is stored in the tanks T2 and T3 and the tank T1 is empty.

When heat stored in the hHTF is required by the HCSS, the process described above is reversed, i.e., hHTF from the tank T2 is sent via the HL into the HCSS, where a portion of thermal energy or heat in the hHTF is transferred to a working fluid of the HCSS, enabling the HCSS to produce electric power and cHTF. The cHTF is then transferred through the CL into the tank T1, which was empty at the start of the heat extraction process. Once all of the hHTF is transferred from the tank T2 through the HCSS and the cHTF is transferred into the tank T1, the tank T2 becomes the empty tank.

After tank T2 is emptied in this manner, hHFT from the tank T3 is transferred through the HL through the HCSS, where a portion of its thermal energy is used to heat a working fluid of the HCSS allowing the HCSS to produce a useable form of energy. The resulting cHTF is transferred through the CL into the tank T2, which was previously emptied.

The entire process is now complete and the system is returned to its initial, fully discharge state, ready to send HTF to the solar collector (or other heat source) to repeat the entire process.

The systems of this invention have a drastically reduced total volume of storage tanks. For instance, is the system of FIG. 2A and described above, a total volume of storage tanks is 150% of a total maximum volume of the HFT in the system. In prior art systems, the total volume of the tanks is generally almost 200% of the total maximum volume of the HTF in the system.

Referring now to FIGS. 2B-I, the process described above is shown pictorially in a sequence of drawings, where T1 and T2 are filled with cHTF (light grey) and T3 is empty. Looking at FIG. 2B, the control unit C set the valves VC1-3 and VH1-3 to open a flow path from T2 through the SHSS to T3 as indicated by the arrows. Looking at FIG. 2C, half of the cHTF in T2 has been heated in the SHSS and stored in T3. Looking at FIG. 2D, T2 is now empty and T3 is filled with hHTF and the control unit C set the valves VC1-3 and VH1-3 to close the flow path from T2 through the SHSS to T3 and to open a flow path from T1 through the SHSS to T2. Looking at FIG. 2E, half of the cHTF in T1 has been heated in the SHSS and stored in T2. Looking at FIG. 2F, T1 is now empty and T2 is filled with hHTF and the control unit C set the valves VC1-3 and VH1-3 to close the flow path from T1 through the SHSS to T2 and open a flow path from T2 through the HCSS to T1. Looking at FIG. 2G, half of the hHTF in T2 has been cooled in the HCSS and stored in T1. Looking at FIG. 2H, T2 is now empty and T1 is filled with cHTF and the control unit C set the valves VC1-3 and VH1-3 to close the flow path from T2 through the HCSS to T1 and to open a flow path from T3 through the HCSS to T2. Looking at FIG. 2I, half of the hHTF in T3 has been cooled in the HCSS and stored in T2. Once this transfer has occurred, the control unit C closes the flow path from T3 through the HCSS to T2 and opens the flow path from T2 through the SHSS to T3 and the cycle is back at the start shown in FIG. 2B.

### Four Tank Embodiment

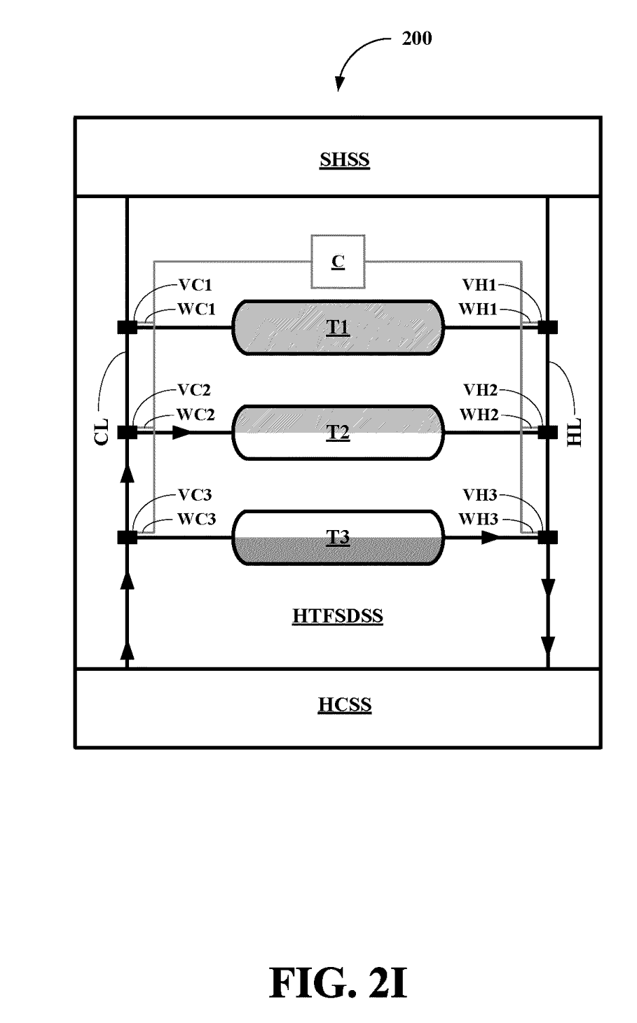

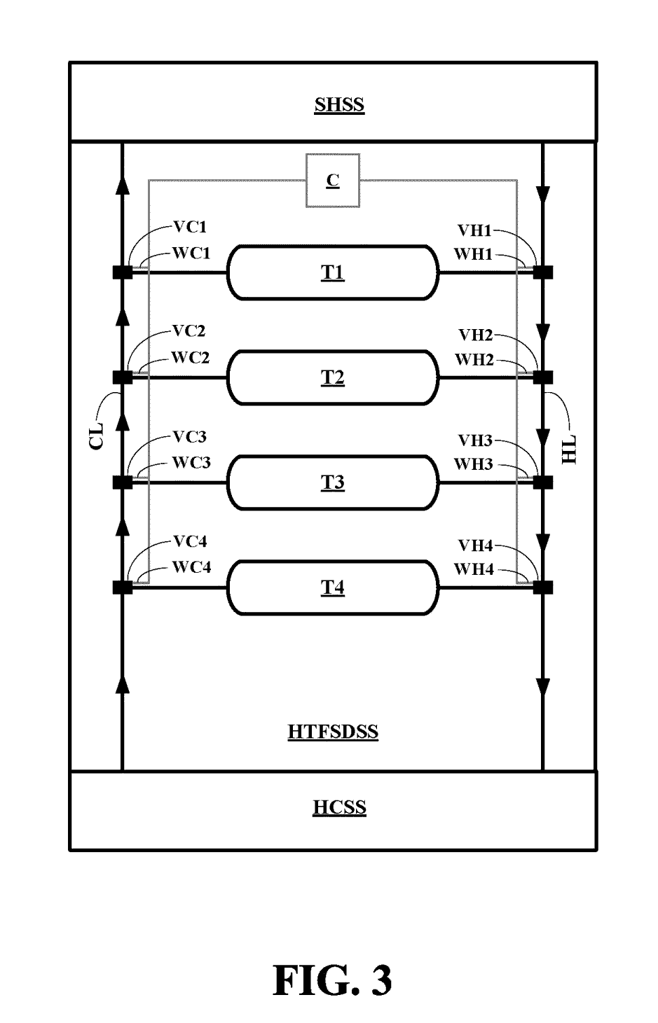

Referring now to FIG. 3, an embodiment of the present solar power system, generally 300, is shown. The system 100 includes a solar heating subsystem SHSS, a heat transfer fluid storage and distribution subsystem HTFSDSS and a heat conversion subsystem HCSS. The HTFSDSS includes three heat fluid storage tanks T1, T2, T3 and T4, a cold HTF transfer line CL, a hot HTF transfer line HL and eight valves VC1-4 and VH1-4 associated with the CL and the HL, respectively. The eight valves in this embodiment are all three way valves. The HTFSDSS also includes a control unit C connected to each of the valves VC1-4 and VH1-4 via wires WC1-4 and WH1-4, respectively, for controlling the valves VC1-4 and VH1-4 to produce desires fluid flow paths between the HTFSDSS and the SHSS or the HCSS. In this embodiment, the HTFSDSS include one empty tank and two filled tanks at a start of a cycle or a half cycle. The filled tanks will either include cold heat transfer fluid (cHTF) or hot heat transfer fluid (hHTF) depending on point within the cycle. The SHSS heats cHTF using solar energy to produce hHTF. The hHTF is transferred to the HTFSDSS, where the hHTF is stored in one or a plurality of empty storage tanks. The hHTF is then transferred to the HCSS, where a portion of the heat of the hHTF is transferred to a working fluid used ultimately to produce a useful form of power. cHFT exiting the HCSS is then stored in empty storage tanks of the HTFSDSS.

The HTFSDSS is connected to the SHSS and to the HCSS via a cHTF pipe or pipeline CL and a hHFT pipe or pipeline HL. Each of the storage tanks T1-4 is, in its turn, connected to both of the CL and the HL. The system operates as follows.

When the system is fully discharge, then tanks T1-3 are filled with cHTF and tank T4 is empty. It should be recognized that the exact tank that is empty is not relevant. All that is required is that at least a single tank be empty and the control unit C know which tank(s) is(are) empty.

At the beginning of system operations, cHTF from the tank T3 is sent through the CL into the SHSS, where the cHTF it is heated to produce hHTF. The hHTF is then sent through the HL into the tank T4, the initially empty tank. The transfer of cHTF from the tank T3 to be heated in the SHSS continues until the tank T3 is emptied of cHTF and the tank T4 is filled with hHTF. In the transfer process, the full tank T3 is emptied becoming the empty tank, and the empty tank T4 is filled becoming a full tank.

Thereafter, cHTF from the other cHTF filled tanks T1-2 is transferred through the CL to the SHSS, where it is heated to produce hHTF and the stored as hHTF in tanks T2-3. As a result, all cHTF in the system is now hHTF and is stored in the tanks T2, T3, and T4, and the tank T1 is empty.

When heat stored in the hHTF is required by the HCSS, the process described above is reversed, i.e., hHTF from the tank T2 is sent via the HL into the HCSS, where a portion of thermal energy or heat in the hHTF is transferred to a working fluid of the HCSS, enabling the HCSS to produce electric power and cHTF. The cHTF is then transferred through the CL into the tank T1, which was empty at the start of the heat extraction process. Once all of the hHTF is transferred from the tanks T2 through the HCSS and the cHTF is transferred into the tank T1, the tank T2 becomes the empty tank.

After tank T2 is emptied in this manner, hHFT from the tank T3 is transferred through the hHTF line through the HCSS, where a portion of its thermal energy is used to heat a working fluid of the HCSS allowing the HCSS to produce a useable form of energy. The resulting cHTF is transferred through the CL into the tank T2, which was previously emptied.

This process is now repeated with the other tanks until the hHTF in tank T4 is converted to cHTF in the HCSS and stored in the previously emptied tank T3. At the end of the heat conversion process, the tanks T1-3 are now filled with cHTF, and tank T4 is empty.

The entire process is now complete and the system is returned to its initial, fully discharge state, ready to send cHTF to the solar collector (or other heat source) to repeat the entire process.

In this embodiment, a total volume of storage tanks is 133% of a total maximum volume of the HFT in the system. In prior art systems, the total volume of the tanks is generally almost 200% of the total maximum volume of the HTF in the system.

### Five Tank Embodiment

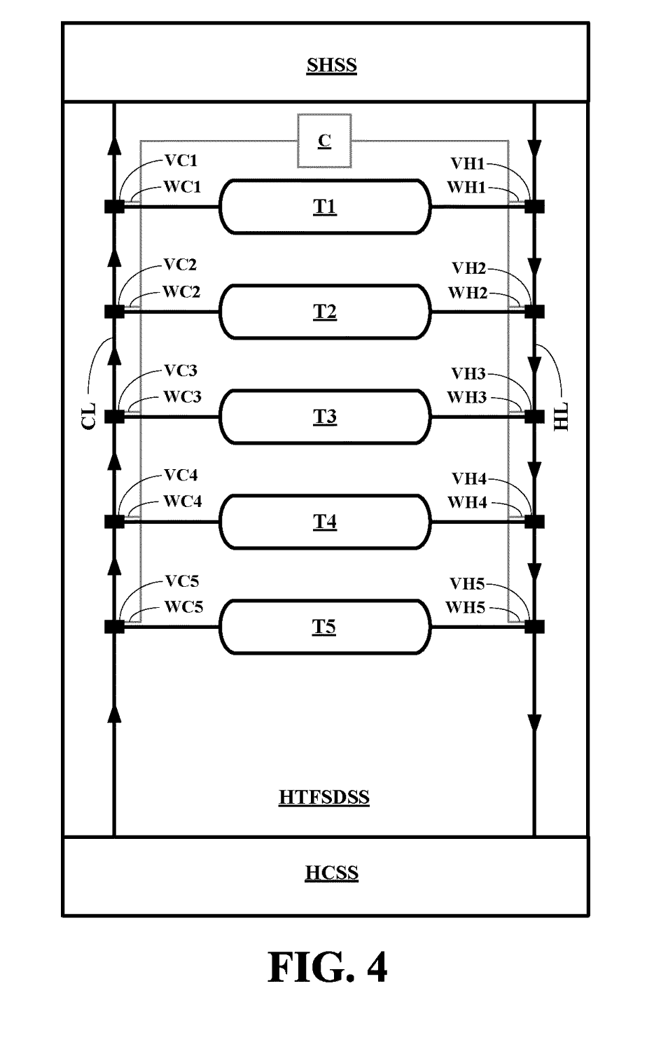

Referring now to FIG. 4, an embodiment of the present solar power system, generally 300, is shown. The system 300 includes a solar heating subsystem SHSS, a heat transfer fluid storage and distribution subsystem HTFSDSS and a heat conversion subsystem HCSS. The HTFSDSS includes three heat fluid storage tanks T1, T2, T3, T4, and T5, a cold HTF transfer line CL, a hot HTF transfer line HL and ten valves VC1-5 and VH1-5 associated with the CL and the HL, respectively. The eight valves in this embodiment are all three way valves. The HTFSDSS also includes a control unit C connected to each of the valves VC1-5 and VH1-5 via wires WC1-5 and WH1-5, respectively, for controlling the valves VC1-5 and VH1-5 to produce desires fluid flow paths between the HTFSDSS and the SHSS or the HCSS. In this embodiment, the HTFSDSS include one empty tank and two filled tanks at a start of a cycle or a half cycle. The filled tanks will either include cold heat transfer fluid (cHTF) or hot heat transfer fluid (hHTF) depending on point within the cycle. The SHSS heats cHTF using solar energy to produce hHTF. The hHTF is transferred to the HTFSDSS, where the hHTF is stored in one or a plurality of empty storage tanks. The hHTF is then transferred to the HCSS, where a portion of the heat of the hHTF is transferred to a working fluid used ultimately to produce a useful form of power. cHFT exiting the HCSS is then stored in empty storage tanks of the HTFSDSS.

The HTFSDSS is connected to the SHSS and to the HCSS via a cHTF pipe or pipeline CL and a hHFT pipe or pipeline HL. Each of the storage tanks T1-5 is, in its turn, connected to both of the CL and the HL. The system operates as follows.

When the system is fully discharge, then tanks T1-4 are filled with cHTF and tank T5 is empty. It should be recognized that the exact tank that is empty is not relevant. All that is required is that a single tank be empty and the control unit know which tank is empty.

At the beginning of system operations, cHTF from tank T4 is sent through the CL into the SHSS, where the cHTF it is heated to produce hHTF. The hHTF is then sent through the HL into tank T5, the initially empty tank. The transfer of cHTF from the tank T4 to be heated in the SHSS continues until the tank T4 is emptied of cHTF and the tank T5 is filled with hHTF. In the transfer process, the full tank T4 is emptied becoming the empty tank, and the empty tank T5 is filled becoming a full tank.

Thereafter, cHTF from the full tank T3 is transferred through the CL to the SHSS, where it is heated to produce hHTF. The hHTF from the tank T3 is transferred through the HL to the tank T4, which was previously emptied. Again the HTF transfer process continues until the tank T3 is full of hNTF and the tank T4 is empty.

This transfer process is then repeated, with cHTF from the tank T2 heated and stored in the now empty tank T3, and so on, till cHTF in the tank T1 is heated and stored in the tank T2.

As a result, all cHTF in the system is now hHTF and is stored in the tanks T2, T3, T4, and T5, and the tank T1 is empty.

When heat stored in the hHTF is required by the HCSS, the process described above is reversed, i.e., hHTF from the tank T2 is sent via the hHTF line into the HCSS, where a portion of thermal energy or heat in the hHTF is transferred to a working fluid of the HCSS, enabling the HCSS to produce electric power and cHTF. The cHTF is then transferred through the cHTF line into the tank T1, which was empty at the start of the heat extraction process. Once all of the hHTF is transferred from the tank T2 through the HCSS and the cHTF is transferred into the tank T1, the tank T2 becomes the empty tank.

After tank T2 is emptied in this manner, hHFT from the tank T3 is transferred through the hHTF line through the HCSS, where a portion of its thermal energy is used to heat a working fluid of the HCSS allowing the HCSS to produce a useable form of energy. The resulting cHTF is transferred through the cHTF line into the tank T2, which was previously emptied.

This process is now repeated with the other tanks until the hHTF in the tank T5 is converted to cHTF in the HCSS and stored in the previously emptied tank T4. At the end of the heat conversion process, the tanks T1, T2, T3, and T4 are now filled with cHTF, and tank T5 is empty.

The entire process is now complete and the system is returned to its initial, fully discharge state, ready to send HTF to the solar collector (or other heat source) to repeat the entire process.

In this embodiment, a total volume of storage tanks is 125% of a total maximum volume of the HFT in the system. In prior art systems, the total volume of the tanks is generally almost 200% of the total maximum volume of the HTF in the system.

### Six Tank Embodiment

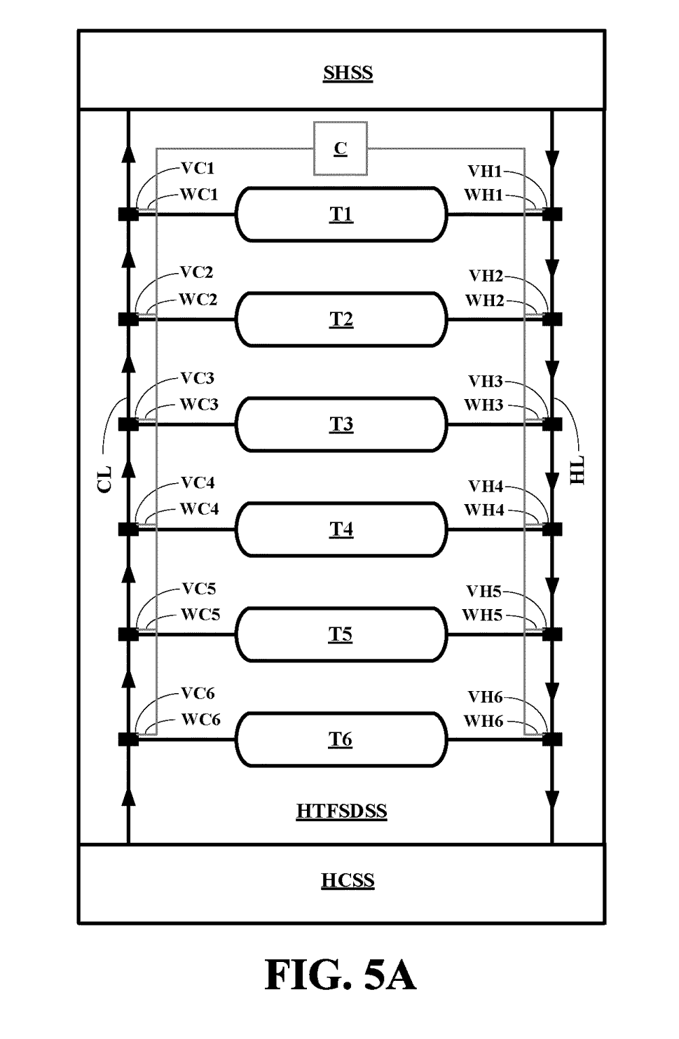

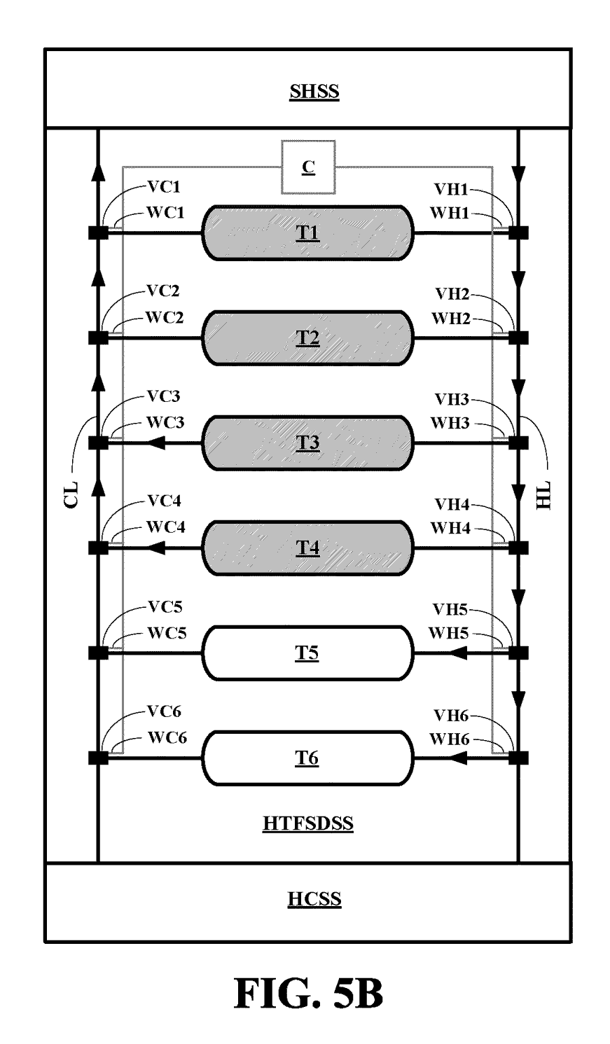

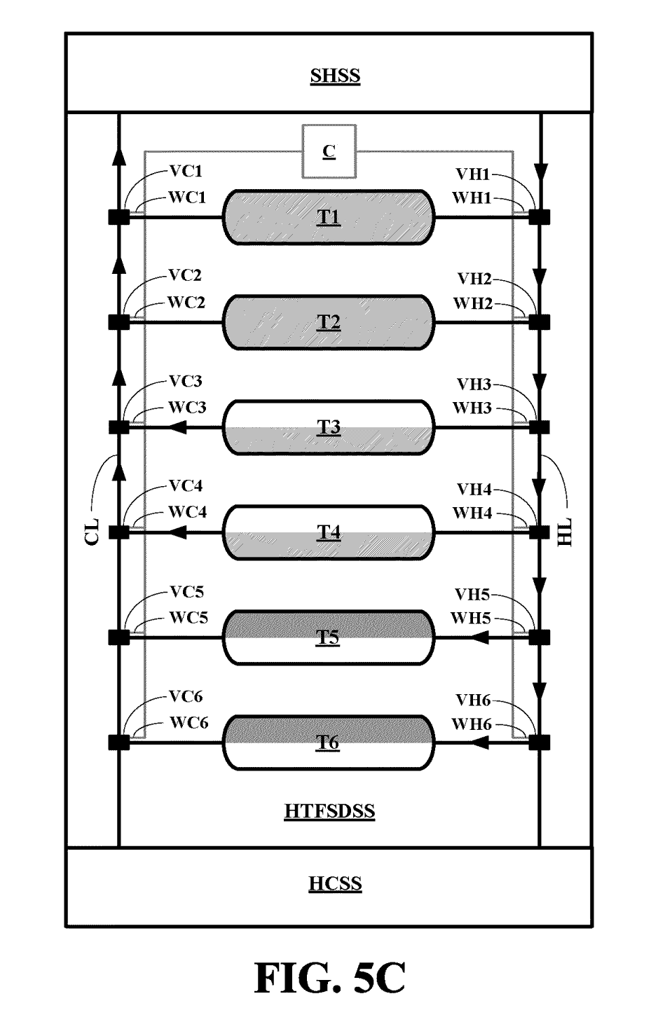

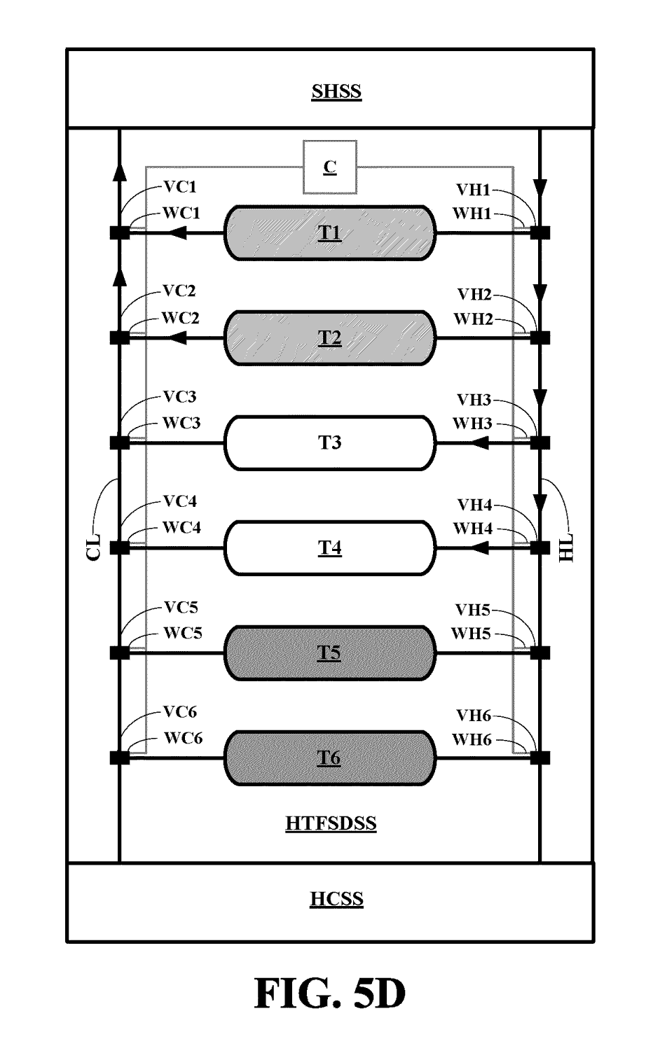

Referring now to FIG. 5A, an embodiment of the present solar power system, generally 300, is shown. The system 100 includes a solar heating subsystem SHSS, a heat transfer fluid storage and distribution subsystem HTFSDSS and a heat conversion subsystem HCSS. The HTFSDSS includes three heat fluid storage tanks T1, T2, T3, T4, T5 and T6, a cold HTF transfer line CL, a hot HTF transfer line HL and ten valves VC1-6 and VH1-6 associated with the CL and the HL, respectively. The eight valves in this embodiment are all three way valves. The HTFSDSS also includes a control unit C connected to each of the valves VC1-6 and VH1-6 via wires WC1-6 and WH1-6, respectively, for controlling the valves VC1-6 and VH1-6 to produce desires fluid flow paths between the HTFSDSS and the SHSS or the HCSS. In this embodiment, the HTFSDSS include one empty tank and two filled tanks at a start of a cycle or a half cycle. The filled tanks will either include cold heat transfer fluid (cHTF) or hot heat transfer fluid (hHTF) depending on point within the cycle. The SHSS heats cHTF using solar energy to produce hHTF. The hHTF is transferred to the HTFSDSS, where the hHTF is stored in one or a plurality of empty storage tanks. The hHTF is then transferred to the HCSS, where a portion of the heat of the hHTF is transferred to a working fluid used ultimately to produce a useful form of power. cHFT exiting the HCSS is then stored in empty storage tanks of the HTFSDSS.

The HTFSDSS is connected to the SHSS and to the HCSS via a cHTF pipe or pipeline CL and a hHFT pipe or pipeline HL. Each of the storage tanks T1-6 is, in its turn, connected to both of these lines. The system operates as follows.

When the system is fully discharge, then tanks T1-5 are filled with cHTF and tank T6 is empty. It should be recognized that the exact tank that is empty is not relevant. All that is required is that a single tank be empty and the control unit know which tank is empty.

At the beginning of system operations, cHTF from tank T5 is sent through the CL into the SHSS, where the cHTF it is heated to produce hHTF. The hHTF is then sent through the HL into tank T6, the initially empty tank. The transfer of cHTF from the tank T5 to be heated in the SHSS continues until the tank T5 is emptied of cHTF and the tank T6 is filled with hHTF. In the transfer process, the full tank T5 is emptied becoming the empty tank, and the empty tank T6 is filled becoming a full tank.

Thereafter, cHTF from the full tank T4 is transferred through the CL to the SHSS, where it is heated to produce hHTF. The hHTF from the tank T4 is transferred through the HL to the tank T5, which was previously emptied. Again the HTF transfer process continues until the tank T5 is full of hNTF and the tank T4 is empty.

This transfer process is then repeated, with cHTF from the tank T3 heated and stored in the now empty tank T4, and so on, till cHTF in the tank T1 is heated and stored in the tank T2.

As a result, all cHTF in the system is now hHTF and is stored in the tanks T2, T3, T4, T5 and T6, and the tank T1 is empty.

When heat stored in the hHTF is required by the HCSS, the process described above is reversed, i.e., hHTF from the tank T2 is sent via the hHTF line into the HCSS, where a portion of thermal energy or heat in the hHTF is transferred to a working fluid of the HCSS, enabling the HCSS to produce electric power and cHTF. The cHTF is then transferred through the cHTF line into the tank T1, which was empty at the start of the heat extraction process. Once all of the hHTF is transferred from the tank T2 through the HCSS and the cHTF is transferred into the tank T1, the tank T2 becomes the empty tank.

After tank T2 is emptied in this manner, hHFT from the tank T3 is transferred through the hHTF line through the HCSS, where a portion of its thermal energy is used to heat a working fluid of the HCSS allowing the HCSS to produce a useable form of energy. The resulting cHTF is transferred through the cHTF line into the tank T2, which was previously emptied.

This process is now repeated with the other tanks until the hHTF in the tank T6 is converted to cHTF in the HCSS and stored in the previously emptied tank T5. At the end of the heat conversion process, the tanks T1, T2, T3, T4 and T5 are now filled with cHTF, and tank T6 is empty.

The entire process is now complete and the system is returned to its initial, fully discharge state, ready to send HTF to the solar collector (or other heat source) to repeat the entire process.

In this embodiment, a total volume of storage tanks is 120% of a total maximum volume of the HFT in the system. In prior art systems, the total volume of the tanks is generally almost 200% of the total maximum volume of the HTF in the system.

If more tanks are used, for example 11 tanks instead of six tanks, then the total volume of storage tanks is further reduced. For 11 tanks, the total volume of the storage tanks is only 110% of the total volume of the HTF in the system.

In all cases, the total number of tanks will be equal to N+1, where N is the number of tanks filled with the HFT at the start or completion of a cycle. Of courses, during operation, the number of filled tanks is still N, but one of the tanks is being empties, while another tank is being filled. Thus, there is always one tank volume empty during all facets of the operation process of the system. In certain embodiment, N, an integer, has a value between 3 and about 100. In other embodiments, N has a value between 3 and about 50. In other embodiments, N has a value between 3 and about 20. In other embodiments, N has a value between 3 and about 15.

Such a reduction in the volume of storage tanks allows for a corresponding reduction in the total costs of the entire storage system. One experienced in the art can easily choose a total number of tanks to attain a best case from the point of view of economic and operational considerations.

Referring now to FIGS. 5B-D, the process described above is shown pictorially in a sequence of drawings, where tanks T1-4 are filled with cHTF (light grey) and tanks T5&6 are empty. Looking at FIG. 5B, the control unit C set the valves VC1-6 and VH1-6 to open flow paths from T3&4 through the SHSS to T5&6 as indicated by the arrows. Looking at FIG. 5C, half of the cHTF in T3&4 has been heated in the SHSS and stored in T5&6. Looking at FIG. 5D, T3&4 are now empty and T5&6 are filled with hHTF and the control unit C set the valves VC1-6 and VH1-6 to close the flow paths from T3&4 through the SHSS to T5&6 and to open flow paths from T1&2 through the SHSS to T3&4. Once this transfer is complete, T3-6 are filled with hHTF. The control unit C then sequentially set the valves VC1-6 and VH1-6 to open and close flow paths from the filled tanks through the HCSS to the empty tanks in pairs until the system is returned to its initial state, with tanks T1-4 full of cHTF and T5&6 empty.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A solar power system comprising:
a heat transfer fluid storage and distribution subsystem (HTFSDSS) including N storage tanks, M empty storage tanks, control valves, and transfer lines, where the HTFSDSS stores and distributes cold heat transfer fluid or hot heat transfer fluid;
a solar heating or collector subsystem (SHSS) connected to the HTFSDSS via the transfer lines, where the SHSS heats cold heat transfer fluid to produce hot heat transfer fluid;
a heat conversion or power subsystem (HCSS) connected to the HTFSDSS via the transfer lines, where the HCSS transfers a portion of thermal energy or heat from the hot heat transfer fluid to a working fluid and converts a portion of the heat in the working fluid to a useable form or energy to produce cold heat transfer fluid,
where N is an integer having a value greater than or equal to 3, where M is an integer having a value less than N and where the HTFSDSS opens flow paths for transferring heat transfer fluid from L filled tanks through either the SHSS or the HCSS and where L is an integer having a value less than or equal to M.

2. The system of claim 1, wherein N has a value between 3 and 20, M has a value between 1 and 3, and L has a value between 1 and 3.

3. The system of claim 1, wherein N has a value between 3 and 20, M has a value between 1 and 3, and L is equal to M.

4. The system of claim 1, wherein N has a value between 3 and 20 and M is 1 and L is 1.

5. The system of claim 1, wherein N has a value between 4 and 20, and M and L are 2.

6. The system of claim 1, wherein N has a value between 6 and 18, and M and L are 3.

7. A method comprising:
sequentially creating a flow path between L tanks of a heat transfer fluid storage and distribution subsystem (HTFSDSS) including N storage tanks, M empty storage tanks, control valves, and transfer lines through the transfer lines to a solar heating or collector subsystem (SHSS);
sequentially transferring cold heat transfer fluid (cHTF) from L tanks filled with the cHTF through the SHSS, where the SHSS heats the cHTF to form hHTF;
storing the hHTF in L empty tanks of the HTFSDSS; and
continuing the previous three steps until N-M tanks filled with cHTF are filled with N-M tanks of hHTF.

8. The method of claim 7, further comprising:
sequentially creating a flow path between L tanks of the HTFSDSS through the transfer lines to a heat conversion or power subsystem (HCSS);
sequentially transferring the hHTF from L tanks filled with hHTF through the HCSS, where the HCSS transfers a portion of heat or thermal energy from the hHTF to a working fluid of the HCSS and cools the hHTF to form cHTF;
storing the hHTF in L empty tanks of the HTFSDSS; and
continuing previously three steps until all of the hHTF is cooled to cHTF.

9. The method of claim 7, wherein N has a value between 3 and 20, M has a value between 1 and 3, and L has a value between 1 and 3.

10. The method of claim 7, wherein N has a value between 3 and 20, M has a value between 1 and 3, and L is equal to M.

11. The method of claim 7, wherein N has a value between 3 and 20 and M is 1 and L is 1.

12. The method of claim 7, wherein N has a value between 4 and 20, and M and L are 2.

13. The method of claim 7, wherein N has a value between 6 and 18, and M and L are 3.

14. The method of claim 8, wherein N has a value between 3 and 20, M has a value between 1 and 3, and L has a value between 1 and 3.

15. The method of claim 8, wherein N has a value between 3 and 20, M has a value between 1 and 3, and L is equal to M.

16. The method of claim 8, wherein N has a value between 3 and 20 and M is 1 and L is 1.

17. The method of claim 8, wherein N has a value between 4 and 20, and M and L are 2.

18. The method of claim 8, wherein N has a value between 6 and 18, and M and L are 3.

19. The method of claim 8, further comprising repeating the steps of claim 7 and claim 8 on a periodic basis.

20. The method of claim 19, wherein period is daily.

21. A method comprising:
heating cold heat transfer fluid (cHTF) stored in N-M tanks of a heat transfer fluid storage and distribution subsystem (HTFSDSS) including N storage tanks, M empty storage tanks, control valves, and transfer lines in a solar heating or collector subsystem (SHSS) to form hot heat transfer fluid (hHTF);
storing the hHTF in N-M tanks of the HTFSDSS; and
transferring a portion of heat from hHTF stored in N-M tanks HTFSDSS to a working fluid of a heat conversion or power subsystem (HCSS) to form cHTF; and
storing the cHTF in N-M tanks of the HTFSDSS.

22. The method of claim 21, wherein N has a value between 3 and 20, M has a value between 1 and 3, and L has a value between 1 and 3.

23. The method of claim 21, wherein N has a value between 3 and 20, M has a value between 1 and 3, and L is equal to M.

24. The method of claim 21, wherein N has a value between 3 and 20 and M is 1 and L is 1.

25. The method of claim 21, wherein N has a value between 4 and 20, and M and L are 2.

26. The method of claim 21, wherein N has a value between 6 and 18, and M and L are 3.

27. The method of claim 21, further comprising repeating the steps of claim 19 on a periodic basis.

28. The method of claim 27, wherein period is daily.
